(19) United States
(12) Patent Application Publication
(10) Pub. No.: US 2009/0076846 A1
(43) Pub. Date: Mar. 19, 2009

(54) MEDICAL SEARCH CLINICAL INTERACTION

(75) Inventors: Isaac Bentwich, D.N. Misgav (IL); Eyal Shavit, Concord, MA (US); Lloyd E. Shefsky, Highland Park, IL (US)

Correspondence Address: OCCHIUTI ROHLICEK & TSAO, LLP, 10 FAWCETT STREET, CAMBRIDGE, MA, 02138, US

(73) Assignee: SOPHIA MEDICAL LLC, Lexington, MA (US)

(21) Appl. No.: 12/233,768

(22) Filed: Sep. 19, 2008

Related U.S. Application Data
(60) Provisional application No. 60/973,460, filed on Sep. 19, 2007.

(51) Int. Cl. G06Q 50/00

(52) U.S. Cl. 705/2

(57) ABSTRACT

In searching medical information, problem oriented information related to a medical condition is solicited from a patient. Based at least in part on the problem oriented information, a plurality of findings are determined about the patient. Based at least in part on the plurality of findings, a plurality of queries associated with said medical condition are determined. Based at least in part on the plurality of queries, search is conducted to find information relevant to the medical condition.

### CROSS-REFERENCE TO RELATED APPLICATIONS

This application claims the benefit of U.S. Provisional Application No. 60/973,460, filed Sep. 19, 2007, the content of which is incorporated herein by reference.

### BACKGROUND

This invention relates to medical search and clinical interaction.

The vast amount of medical information accessible to the public, for example, available over the Internet, provides an opportunity for many people to seek information (such as disease knowledge and healthcare advice) relevant to various kinds of concerns. In certain cases, however, doctors, clinicians, scientist, patients and other searchers may still face challenges in finding an efficient and effective means to locate information of specific interest. Doctors, for example, usually have access to a wide range of resources such as medical journals and clinical databases, but may have significant constraints on the time that they can spend navigating through the resources to locate relevant information, such as recent advances in medical technology most relevant to his practices. Patients, on the other hand, may not possess the skill or knowledge for using sophisticated medical terminologies to describe or determine the medical conditions to be searched about.

### SUMMARY

One aspect of the invention relates to a method for effective medical search, for example, using clinical data collected from a patient. The method includes: soliciting problem oriented information from a patient related to a medical condition; determining a plurality of findings present in the patient, based at least in part on the problem oriented questionnaire; determining a plurality of queries associated with the medical condition, based at least in part on the the plurality of findings; searching and presenting information relevant to the medical condition, based at least in part on the plurality of queries.

In accordance with another embodiment of the present invention a problem oriented questionnaire is presented to the patient.

In accordance with yet another embodiment of the present invention the plurality of findings associated with a medical condition constitutes a majority of findings that are ascertainable by a patient and are associated with the medical condition.

In accordance with a further embodiment of the present invention the obtaining is based at least in part on receiving data from an existing electronic medical record.

In accordance with an additional embodiment of the present invention the determining is based at least in part on an item selected from the group consisting of: financial data and insurance data.

Another aspect of the invention relates to a personalized medical search engine including: a questionnaire engine operative to display a problem oriented questionnaire associated with a medical condition, and to obtain a plurality of findings present in a patient, based at least in part on the problem oriented questionnaire; a query constructor operative to determine a plurality of keywords associated with the medical condition, based at least in part on the plurality of findings present in the patient, and to construct a query based at least in part on the plurality of keywords; and a data searcher operative to search and present information relevant to the medical condition, based at least in part on the query.

In accordance with another embodiment of the present invention the questionnaire is presented to the patient.

In accordance with yet another embodiment of the present invention the plurality of findings associated with a medical condition constitutes a majority of findings that are ascertainable by a patient and are associated with the medical condition.

In accordance with a further embodiment of the present invention the questionnaire engine is operative to obtain a plurality of findings present in the patient based at least in part on receiving data from an existing electronic medical record.

In accordance with an additional embodiment of the present invention the query constructor is operative to determine a plurality of keywords associated with the medical condition, based at least in part on an item selected from the group consisting of: financial data and insurance data.

Another aspect of the invention relates to a method for searching medical information including: obtaining data from a patient; determining a plurality of findings present in the patient, based at least in part on the obtaining; determining a plurality of keywords associated with the medical condition, based at least in part on the extracting; searching and presenting information relevant to the medical condition, based at least in part on the plurality of keywords.

In accordance with another embodiment of the present invention the plurality of findings associated with a medical condition constitutes a majority of findings that are ascertainable by a patient and are associated with the medical condition.

In accordance with yet another embodiment of the present invention the extracting is based at least in part on receiving data from an existing electronic medical record.

In accordance with a further embodiment of the present invention the determining is based at least in part on an item selected from the group consisting of: financial data and insurance data.

Another aspect of the invention relates to a personalized medical search engine including: a data intake module operative to obtain data from a patient, and extract from the data a plurality of findings present in the patient; a query constructor operative to determine a plurality of keywords associated with the medical condition, based at least in part on the plurality of findings present in the patient, and to construct a query based at least in part on the plurality of keywords; and a data searcher operative to search and present information relevant to the medical condition, based at least in part on the query.

In accordance with another embodiment of the present invention the plurality of findings associated with a medical condition constitutes a majority of findings that are ascertainable by a patient and are associated with the medical condition.

In accordance with yet another embodiment of the present invention the data intake module is operative to receive data from an existing electronic medical record, and to extract a plurality of findings present in the patient, based at least in part on the data.

In accordance with a further embodiment of the present invention the data intake module is operative to obtain a plurality of findings present in the patient based at least in part on an item selected from the group consisting of: financial data and insurance data.

Another aspect of the invention relates to a system and method for managing a clinical interaction, including soliciting information related to a clinical interaction from a subject; in response to the soliciting of information, accepting information from the subject; and processing the accepted information, including forming a report for a clinical practitioner representing at least some of the accepted information in a text passage.

Embodiments of this aspect may include one or more of the following features.

The method may further include accessing medical history information for the subject. At least some of the medical history information is represented in the report.

The method may further include using the information accepted from the subject to locate supplemental information. The report formed for the clinical practitioner may include information representing the supplemental information. The supplemental information may include clinical resources.

A report may be formed for the subject and/or an insurer. A financial incentive may be provided to the subject for providing the solicited information prior to a direct interaction with the clinical practitioner.

Advantages of aspects can include one or more of the following.

Interaction between a patient and a doctor can be made more efficient. Increased efficiency can reduce cost by reducing the required amount of communication time during clinical sessions. Increased efficiency can also reduce chance of medical errors by missing relevant information in patient's medical history or in clinical resources. Reduced chance of error can reduce cost due to unnecessary treatment.

Other features and advantages of the invention are apparent from the following description, and from the claims.

### DESCRIPTION OF DRAWINGS

FIG. 1 is a block diagram illustrating an embodiment of a personalized medical search engine.

FIG. 2 is a block diagram illustrating operation of an embodiment of a clinical interaction engine, which is a component of the personalized medical search engine shown in FIG. 1.

FIG. 3 is a block diagram illustrating a clinical interaction system.

FIG. 4 is a flow diagram illustrating operation of the clinical interaction system shown in FIG. 3.

### DESCRIPTION

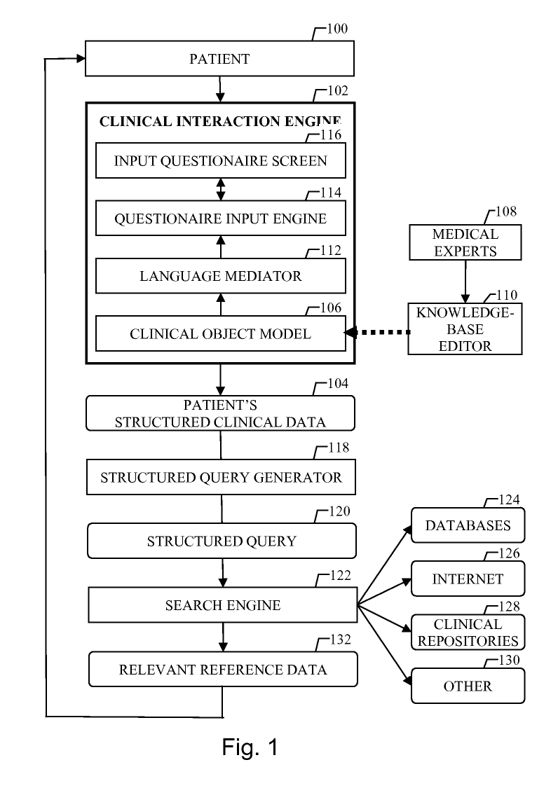

Reference is now made to FIG. 1, which is a block diagram describing an embodiment of a personalized medical search engine.

The personalized medical search engine is configured to provide an effective means for a patient, as well as for healthcare professionals, to easily conduct a search for medical information specifically relevant to his/her medical condition and specific symptoms. Despite the availability of generic search engines that search the internet and various databases for information, searching for medical information relevant to a specific patient's medical condition remains difficult and ineffective. This is especially true, when a patient, who is not a medical professional, tries to search for information relating to his condition and to his/her specific symptoms.

One example of the personalized medical search engine includes a clinical interaction engine 102 for guiding a user, such as a patient 100, in collecting clinical data on his medical condition, preferably structured clinical data, referred to here as patient's structured clinical data 104. This structured clinical data 104, can in turn be used as effective ‘keywords’ in searching for medical information relevant to the patient's condition. The patient's structured clinical data 104 may include patient's financial data and insurance data. The clinical interaction engine 102 may also extract relevant clinical information from an existing database, such as an electronic medical record system.

In some examples, the clinical interaction engine 102 is configured based on an extensive clinical object model 106, which is created, for example, by medical experts 108 using a knowledge-base editor 110.

A language mediator 112 may optionally be used to mediate between the clinical object model 106, which is language independent, and input questionnaires based on thereupon, which are language dependent. The language mediator 112 is further described herein below.

A questionnaire engine 114 is operative to generate and manage one or more input questionnaire screen 116, which prompt the user 100 to enter medical information relevant to his medical condition.

The patient's structured clinical data 104 is passed on to a structured query generator 118, which generates a structured query 120, based at least in part on the patient's structured clinical data 104.

A search engine 122 is then used, based on the structured query 120, to seek information specifically relevant to the medical condition and symptoms of the patient 100, as reflected in the patient's structured clinical data 104. It is appreciated that the search engine 122 may be one of various broadly available search engines, such as internet search engines, database search engines, etc.

The search engine 122 preferably searches various medical databases 124, internet 126, clinical repositories 128, or other 130 sources of information.

The results of this search are relevant reference data 132, which are relevant to the patient's medical symptoms and condition and to the patient's structured clinical data 104, are returned to the patient 100.

It is appreciated that while collection of clinical data is described herein below as collection of structured clinical data (patient's structured clinical data 104), this is provided as an example only, and is not meant to be limiting. Clinical data may be collected as non-structured data, and structured data may be deduced or extracted from the non-structured data.

It is further appreciated that the embodiment of the clinical interaction engine 102 described herein below is provided as an example only and is not meant to be limiting: Clinical data may be collected utilizing differently designed computer hardware or software, or by various modes of a user interacting with a system having a computer software element.

An advantage of the clinical interaction engine 102 is that it provides the user a means for collecting or extracting structured clinical data, which in turn can be used to facilitate an effective search for medical information relevant to the structured clinical data.

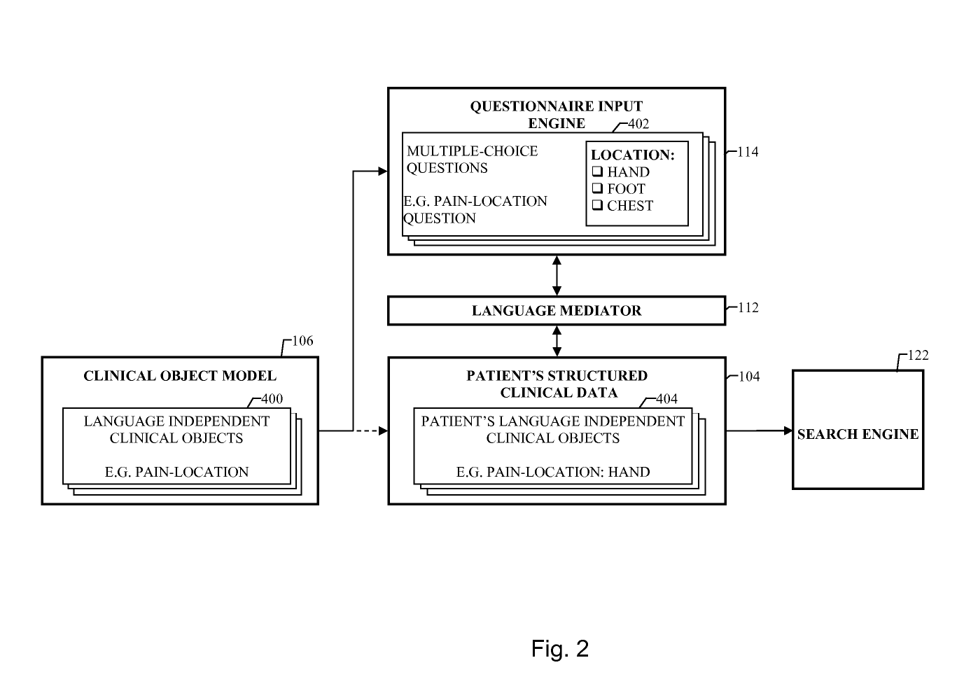

Reference is now made to FIG. 2, which is a block diagram illustrating operation of an embodiment of the clinical interaction engine 102 of FIG. 1.

FIG. 2 provides an example, which illustrates the operation of the clinical interaction engine 102 and its various components and the clinical object model 106.

The clinical interaction engine 102 is based on the clinical object model 106, which comprises multiple language independent clinical objects 400. An example for one of these language independent clinical objects 400 is “pain-location.” The term ‘language independent’ here generally refers to a pure clinical finding, which is independent of the language in which it is expressed. For example, ‘pain-location’ is a pure clinical statement. It may be expressed in different English words or phrases (‘location of pain’, ‘painful region’, ‘where I feel tenderness’, etc.), and may indeed be similarly stated in any other language, but all these different language independent statements, can be mapped to this one clinical statement.

The questionnaire input engine 114 of FIG. 1 comprises a plurality of multiple-choice questions 402, which may preferably correspond to one of the language independent clinical objects 400. In the example above, the questionnaire input engine 114 would include a ‘pain-location’ question. As an example, this can be a multiple-choice question, titled ‘location’, and having various answers, which the user may select, such as hand, foot and chest.

User-selected answers to any one of the multiple choice questions 402, are stored as one of plurality of patient's language independent clinical objects 404, comprised in the patient's structured clinical data 104 of FIG. 1. As an example, if the user selected ‘hand’ in the above mentioned ‘location’ question, then a patient's language independent clinical object 404 ‘pain-location: hand’ would be stored to the patient's structured clinical data 104. The object ‘pain-location: hand’ is referred to here as language independent, because it is a clinical statement, of clinical significance: it may be expressed in different words and synonyms (e.g. ‘my hand hurts’, ‘I feel pain in my hand’, ‘the patient reports pain in his hand’, etc.), in different languages, but would still carry the same clinical meaning.

It is appreciated that the patient's language independent clinical objects 404 comprises a very small subset of the language independent clinical objects 400. In other words, the symptoms, findings, medications and recommendations etc., that a specific patient has are always a very small subset of the entire pool of those existing in the entire field of medicine.

It is appreciated that in a preferred embodiment of the present invention, the multiple choice questions 402 are language dependent, i.e. are presented to users 300 in a language, such as in English. In contrast, the data corresponding to these is stored in the patient's structured clinical data 104, as language independent, i.e. as patient's language independent clinical objects 404. The language mediator 320 of FIG. 1 is therefore preferably used to mediate between the language dependent multiple choice questions 402 and between the patient's language independent clinical objects 404.

Patient's language independent clinical objects 404 of the patient's structured clinical data 104 are then used by the search engine 122, and enable it to retrieve relevant reference data 132.

Some embodiments relate to managing clinical interaction between multiple parties, including, for example, patients, healthcare professionals, and insurance companies, for improving the efficiency of such interactions.

Technology advances in the medical device industry have lowered the cost of many computer-aided diagnostic and therapeutic services (e.g., ultrasound imaging, x-ray scanning and magnetic resonance imaging) available to the public. However, annual health care expenses for individuals remain high. This results in part from the continued high rates of traditional health care services, such as in-person clinical consultations offered by well-trained medical professionals (e.g., physicians and specialists). As a major cost component in the current billing system, the time length of such doctor-patient encounters may not be easily reduced for many reasons.

In a meeting with a patient, a doctor may first need to review patient's medical history and determine whether any past medical conditions may be relevant. This may take several minutes. Next, before any diagnosis is made, a good understanding of the patient's current condition and symptoms needs to be established, often through conversation. Considering the common difficulties in patient's accurate representation of his medical conditions, such communication could take, e.g., up to tens of minutes. In some cases, a miscommunication or misplaced focus of discussion could result in lengthy yet unproductive meetings, or even the risk of a misdiagnosis.

In general, for the doctor to make an accurate diagnosis based on patient's input, a sizable body of medical information needs to be taken into account, e.g., the primary disease categories to consider, the symptoms to look for, the set of physical examinations to perform, and the lab tests to order. When such information is not directly available from past experience or instant memory, the doctor often turns to textbooks or medical journals for answer. Here again, much time may be wasted in search before useful information is located.

Therefore, a system that facilitates clinical interaction and provides an effective search means is useful in improving the quality of traditional healthcare service and reducing healthcare-related cost.

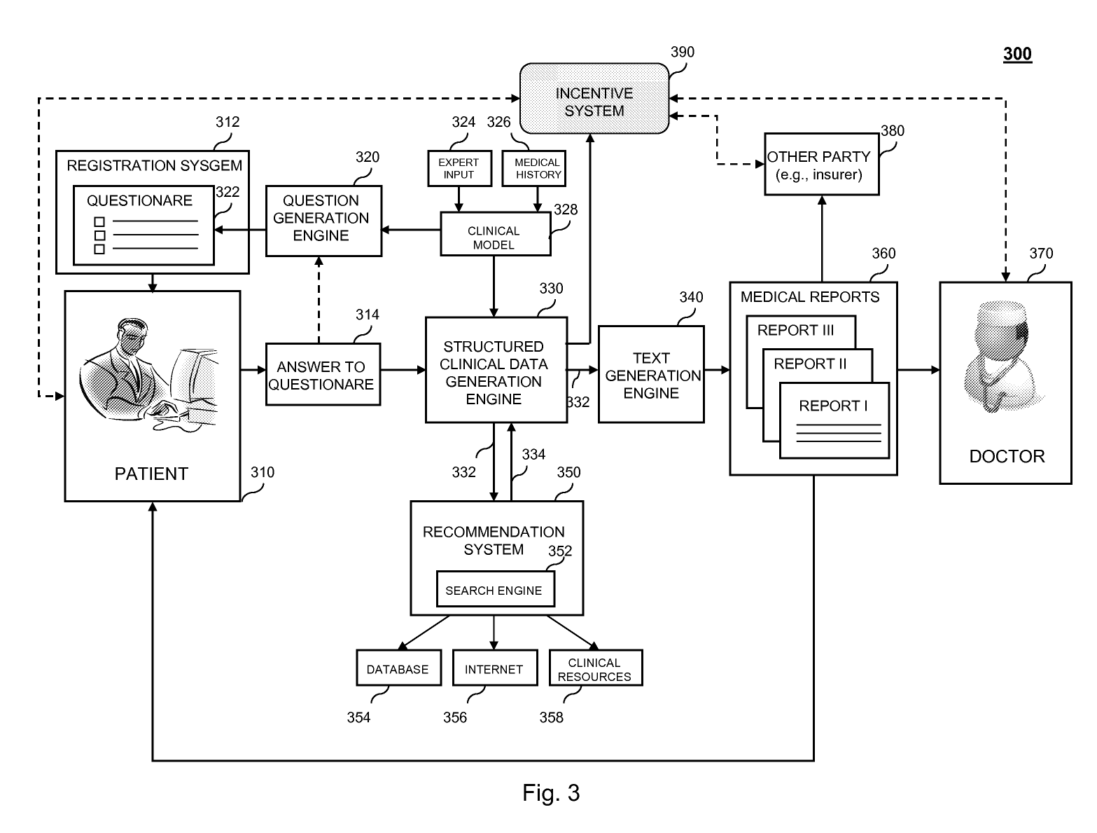

Referring to FIG. 3, a computer-aided clinical interaction system 300 is provided to facilitate communications between a health care receiver, e.g. a patient 310, and a health care provider, e.g., a doctor 370. In some examples, the patient 310 uses the system 300 to schedule clinical sessions with his doctor 370 and to provide clinical information relevant to his medical conditions. Such clinical information is delivered to the doctor 370 in the form of medical reports 360 and used for pre-session and/or in-session review and evaluation.

In some examples, the patient 310 provides his clinical information via a secured web-based registration system 312, which uses structured questionnaires 322 to guide user input. For example, the questionnaires 322 may list a group of multiple choice questions, including e.g., a ‘pain-location’ question with various answers, such as ‘hand’, ‘foot’ and ‘chest’, which the user may select. Preferably, those questions are dynamically generated in a hierarchical manner by a question generation engine 320. The question generation engine 320 uses a knowledge-based clinical model 328 to form the questions based on information from various sources, including expert input 324 and patient medical history 326.

Answers to questionnaires 314 are processed in a structured clinical data generation engine 330, again using the clinical model 328. The results are stored as language independent clinical data 332. Again, “language independent” refers to a pure clinical finding that is independent of the language in which it is expressed. For example, various expressions such as “my hand hurts,” “I feel pain in my hand,” and “the patient reports pain in his hand” that carry the same clinical meaning, can be all mapped to a single language independent clinical statement, i.e., “pain-location: hand.”

In some examples, a recommendation system 350 makes use of some of the structured clinical data 332 to search for relevant medical data 334 applicable to patient's medical condition. Examples of relevant medical data 334 include details of a clinical session scheduled for the patient (e.g. the time and location of the session), medical data relevant to the patient's symptoms (e.g., reported diagnosis of similar symptoms), and medical recommendations to the doctor (e.g., suggested medical procedures and tests in relevant categories).

The recommendation system 350 may include a search engine 352, which uses structured clinical data 332 as effective keywords to conduct search in a variety of resources, including medical databases 354, internet 356, and clinical resources database 358. Once relevant medical data 334 is retrieved, it is further incorporated into the patient's structured clinical data 332, by the structured clinical data generation engine 330, to be reflected in the final reports.

Using the structured clinical data 332, a text generation engine 340 creates medical reports 360 describing the patient's medical conditions in prose that is easily comprehensible to the doctor 370. The medical reports 360 may also provide, based on relevant medical data 334, suggestions on management of the patient's medical conditions (e.g., recommended tests and the most relevant medical findings the doctor needs to consider). The medical reports 360 may also include personal information, such as patient registration profile, insurance information, and account balance.

In some examples, the patient 310 receives a separate report (not illustrated) summarizing his data entry record and/or other session scheduling details. In some other examples, an affiliated third party 380 (e.g., an insurer) may also receive reports about the financial aspects of the upcoming clinical session as well as this pre-session patient registration.

In some examples, the computer-aided clinical interaction system 300 may also have an incentive system 190 for providing incentives for one or multiple parties that makes use of the system 300. Examples of incentives include financial incentives, such as the insurer 380 providing a rebate or discount to the patient 310 or the doctor 370 for each appointment made through the clinical interaction system 300, and non-financial incentives, such as the doctor 370 or a session scheduler offering priority/reserved openings to the patient 310 who is registered in the system 300.

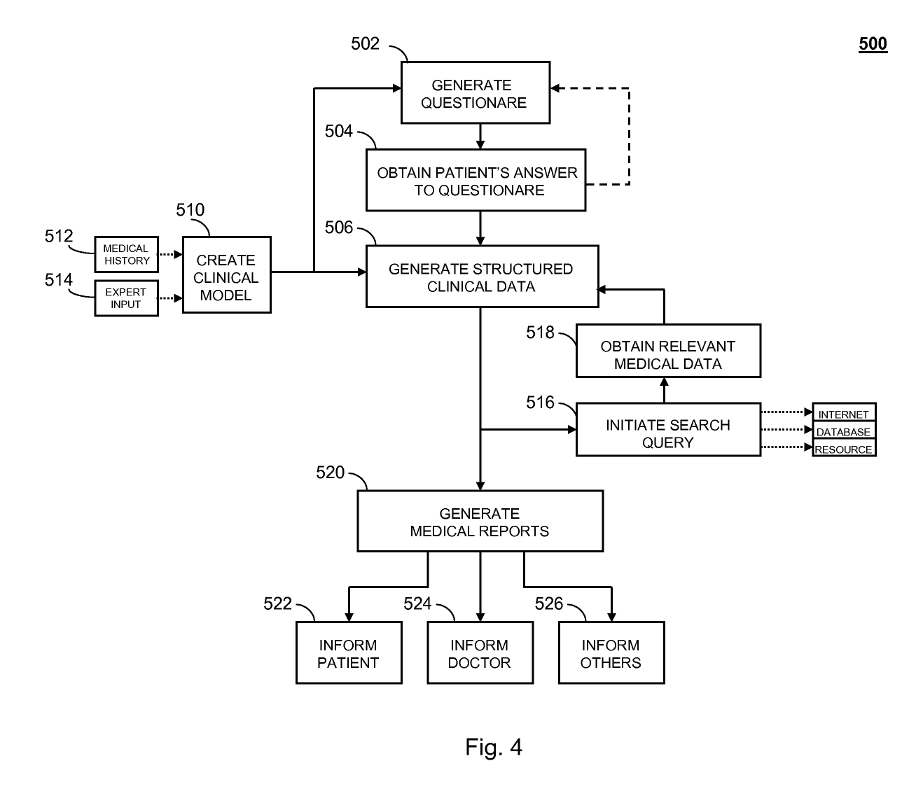

Referring to FIG. 4, the operation of the clinical interaction system 300 is further illustrated in a flow chart 500. In step 502, questionnaires 312 are generated by a question generation engine 320. Upon receiving patient input to the questionnaires 312 (in step 504), structured clinical data is generated (in step 506). Based on at least part of the structured clinical data, the search engine 352 in the recommendation system 350 initiates search queries (in step 516), and obtains relevant medical data (in step 518).

In step 520, medical reports 360 are generated. The medical reports 360 may include multiple versions that are respectively distributed to the doctor 370, the patient 310, and the other party 380. Some text generation techniques that can be used in generating the medical reports 360 are described by Bentwich in U.S. Pat. No. 6,289,513 issued on Sep. 11, 2001, the contents of which are incorporated herein by reference.

It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable subcombination.

Embodiments of the system may be implemented in software, with functions described above being controlled by processor using instructions stored on computer-readable media. Functions can be distributed over a number of different components, for example, centralized on a single server. For example, a patient may interact with a dedicated Kiosk or using a web-based interface. As another example, medical reports may be provided to a doctor in an electronic or printed form.

It is to be understood that the foregoing description is intended to illustrate and not to limit the scope of the invention, which is defined by the scope of the appended claims. Other embodiments are within the scope of the following claims.

What is claimed is:

1. A method for searching medical information comprising:
soliciting problem oriented information from a patient related to a medical condition,
determining a plurality of findings present in said patient, based at least in part on said problem oriented information;
determining a plurality of queries associated with said medical condition, based at least in part on said plurality of findings; and
searching information relevant to said medical condition, based at least in part on said plurality of queries.

2. The method of claim 1, wherein soliciting problem oriented information includes presenting a problem oriented questionnaire.

3. The method of claim 1, wherein said plurality of findings associated with a medical condition constitutes a majority of findings that are ascertainable by a patient and are associated with said medical condition.

4. The method of claim 1, wherein said obtaining the plurality of findings includes:
receiving data from an existing electronic medical record.

5. The method of claim 1, wherein said determining is based at least in part on an item selected from the group consisting of: financial data and insurance data.

6. A personalized medical search engine comprising:
a questionnaire engine configured to display a problem oriented questionnaire related to a medical condition, and to determine a plurality of findings present in a patient, based at least in part on said problem oriented questionnaire;
a query constructor configured to determine a plurality of keywords associated with said medical condition, based at least in part on said plurality of findings present in said patient, and to construct a query based at least in part on said plurality of keywords; and
a data searcher configured to search information relevant to said medical condition, based at least in part on said query.

7. The personalized medical search engine of claim 6, wherein said questionnaire engines is further configured to present said problem oriented questionnaire to said patient.

8. The personalized medical search engine of claim 6, wherein said plurality of findings associated with a medical condition constitutes a majority of findings that are ascertainable by a patient and are associated with said medical condition.

9. The personalized medical search engine of claim 6, wherein said questionnaire engine is further configured to receive data from an existing electronic medical record, and to obtain a plurality of findings present in said patient based at least in part on the data.

10. The personalized medical search engine of claim 6, wherein said query constructor is operative to determine a plurality of keywords associated with said medical condition, based at least in part on an item selected from the group consisting of: financial data and insurance data.

11. A method for searching medical information comprising:
obtaining data from a patient;
determining a plurality of findings present in said patient, based at least in part on said obtaining;
determining a plurality of keywords associated with said medical condition, based at least in part on said extracting;
searching and presenting information relevant to said medical condition, based at least in part on said plurality of keywords.

12. The method of claim 11, wherein said plurality of findings associated with a medical condition constitutes a majority of findings that are ascertainable by a patient and are associated with said medical condition.

13. The method of claim 11, wherein said extracting is based at least in part on receiving data from an existing electronic medical record.

14. The method of claim 11, wherein said determining is based at least in part on an item selected from the group consisting of: financial data and insurance data.

15. A personalized medical search engine comprising:
a data intake module operative to obtain data from a patient, and extract from said data a plurality of findings present in said patient;
a query constructor operative to determine a plurality of keywords associated with said medical condition, based at least in part on said plurality of findings present in said patient, and to construct a query based at least in part on said plurality of keywords; and
a data searcher operative to search and present information relevant to said medical condition, based at least in part on said query.

16. The personalized medical search engine of claim 15, wherein said plurality of findings associated with a medical condition constitutes a majority of findings that are ascertainable by a patient and are associated with said medical condition.

17. The personalized medical search engine of claim 15, wherein said data intake module is operative to receive data from an existing electronic medical record, and to extract a plurality of findings present in said patient, based at least in part on said data.

18. The personalized medical search engine of claim 15, wherein said data intake module is operative to obtain a plurality of findings present in said patient based at least in part on an item selected from the group consisting of: financial data and insurance data.

19. A method for managing a clinical interaction comprising:
soliciting information related to a clinical interaction from a subject;
in response to the soliciting of information, accepting information from the subject; and
processing the accepted information, including forming a report for a clinical practitioner representing at least some of the accepted information in a text passage.

20. The method of claim 19, further comprising accessing medical history information for the subject, and wherein forming the report for the clinical practitioner include representing at least some of the medical history information in the report.

21. The method of claim 19, further comprising using the information accepted from the subject to locate supplemental information, and wherein forming the report for the clinical practitioner includes representing the supplemental information.

22. The method of claim 21, wherein the supplemental information includes clinical resources.

23. The method of claim 19, wherein processing the accepted information further includes forming a report for the subject.

24. The method of claim 19, wherein processing the accepted information further includes forming a report for an insurer.

25. The method of claim 19, further comprising providing a financial incentive to the subject for providing the solicited information prior to a direct interaction with the clinical practitioner.
